(19) United States
(12) Patent Application Publication
(10) Pub. No.: US 2007/0091469 A1
(43) Pub. Date: Apr. 26, 2007

(54) Image-forming lens set

(75) Inventor: Eric Chang, Taichung County (TW)

Correspondence Address: BACON & THOMAS, PLLC, 625 SLATERS LANE, FOURTH FLOOR, ALEXANDRIA, VA, 22314, US

(73) Assignee: GENIUS ELECTRONIC OPTICAL CO. Ltd., Taichung (TW)

(21) Appl. No.: 11/252,709

(22) Filed: Oct. 19, 2005

(51) Int. Cl. G02B 9/14

(52) U.S. Cl. 359/785

(57) ABSTRACT

An image-forming lens set includes a first lens, an aperture, a second lens and a third lens arranged orderly from an objective side toward an image side in sequence. The first lens, the second lens and the third lens are made of plastic material. The first lens has a positive diopter and two opposite surfaces including a convex surface facing the objective side and having at least one of which be a non-spherical surface. The second lens has a negative diopter and two opposite surfaces including a concave surface facing the objective side and having at least one of which be a non-spherical surface. The third lens has a positive diopter and two opposite surfaces including a convex surface facing the objective side and having at least one of which be a non-spherical surface having an inflection point thereon.

### BACKGROUND OF THE INVENTION

1. Field of the Invention

The present invention relates image-forming lenses and more particularly, to an inexpensive image-forming lens set.

2. Description of the Related Art

Following fast development of multimedia technology, image-forming lenses have been intensively sued in a variety of mobile electronic products such as digital camera, mobile camera telephone, and etc., for picking up images. The cameras of these mobile electronic products commonly use a CCD (charge-coupled device) or a CMOS (complementary metal oxide semiconductor) to obtain the image of the objective for storage or transmission to a remote side through a personal computer or cellular telephone.

Following the heavy demand for high-tech products, the quality requirement becomes more critical. Further, in order to survive in the market and to attract consumers to buy, it is quite important to reduce the size of high-tech products for mobility and to lower their cost while maintaining the product quality. The fabrication of image-forming lens sets encounters the same market challenge.

### SUMMARY OF THE INVENTION

The present invention has been accomplished under the circumstances in view. It is one object of the present invention to provide an image-forming lens set that is easy and inexpensive to manufacture and that provides a high image quality.

To achieve this object of the present invention, the image-forming lens set comprises a first lens, an aperture, a second lens and a third lens arranged orderly from an objective side toward an image side in sequence. The first lens, the second lens and the third lens are made of plastic material. The first lens has a positive diopter and two opposite surfaces including a convex surface facing the objective side and having at least one of which be a non-spherical surface. The second lens has a negative diopter and two opposite surfaces including a concave surface facing the objective side and having at least one of which be a non-spherical surface. The third lens has a positive diopter and two opposite surfaces including a convex surface facing the objective side and having at least one of which be a non-spherical surface having an inflection point thereon.

### BRIEF DESCRIPTION OF THE DRAWING

FIG. 1 is a schematic drawing showing the structure of an image-forming lens set according to the present invention.

### DETAILED DESCRIPTION OF THE INVENTION

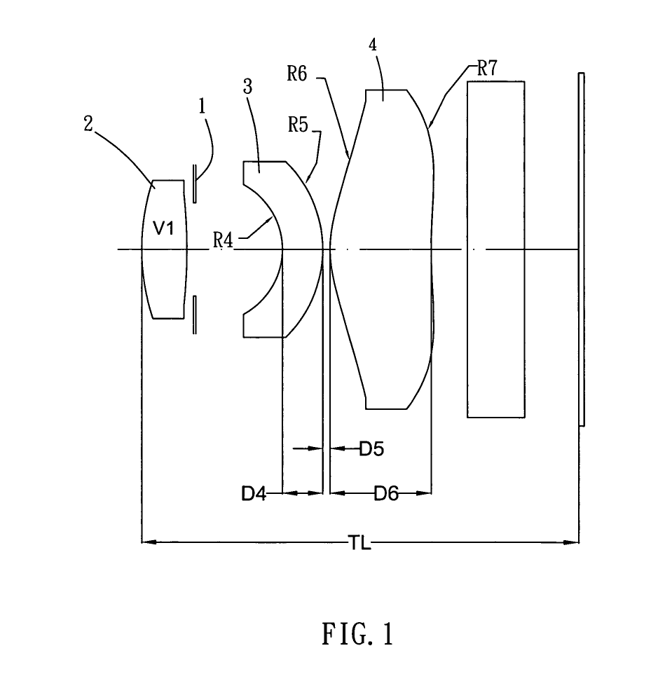

Referring to the annexed drawing of FIG. 1, an image-forming lens set in accordance with the present invention is shown comprising an aperture 1, a first lens 2, a second lens 3, and a third lens 4. The component parts are arranged from the objective side to the image side in the order of: the first lens 2, the aperture 1, the second lens 3, and the third lens 4. The first lens 2 is molded from a resin having two opposite surfaces made non-spherical and respectively facing the objective side and the image side. The surface of the first lens 2 that faces the objective side is a convex surface having a positive diopter. The second lens 3 is molded from a resin, having two opposite surfaces made non-spherical and respectively facing the objective side and the image side. The surface of the second lens 3 that faces the objective side is a concave surface having a negative diopter. The concave surface of the second lens 3 that faces the objective side is so made that the diopter close to the border edge thereof gradually reduces toward the border edge. The third lens 4 is molded from a resin, having two opposite surfaces made non-spherical and respectively facing the objective side and the image side. The surface of the third lens 4 that faces the objective side is a convex surface having a positive diopter. The surface of the third lens 4 that faces the image side is made having an inflection point on the middle. The aperture 1 is set between the first lens 2 and the second lens 3.

The aforesaid image-forming lens set satisfies the following conditions:
TL/f<2

in which:

TL: the distance value between the peak of the convex surface of the first lens 2 that faces the objective side and the image side;

f: the value of the equivalent focal distance of the image-forming lens set.
V1>40

in which:

V1: the dispersion coefficient of the first lens 2;
0.1<|R4|/|R5|<5

in which:

|R4|: the absolute value of the radius of curvature of the concave surface of the second lens 3 that faces the objective side;

|R5|: the absolute value of the radius of curvature of the non-spherical surface of the second lens 3 that faces the image side; wherein the unit of radius of curvature is millimeter.
0.1<|R6|/|R7|

in which:

|R6|: the absolute value of the radius of curvature of the convex surface of the third lens 4 that faces the objective side;

|R7|: the absolute value of the radius of curvature of the non-spherical surface of the third lens 4 that faces the image side; wherein the unit of radius of curvature is millimeter.
D5/f<0.3

in which:

D5: the distance between the peak (the optical axis) of the non-spherical surface of the second lens 3 that faces the image side and the peak (optical axis) of the convex surface of the third lens 4 that faces the objective side.
0.2<D4/D6<2

in which:

D4: the distance between the center (the optical axis) of the concave surface of the second lens 3 that faces the objective side and the center (the optical axis) of the non-spherical surface of the second lens 3 that faces the image side.

D6: the distance between the center (the optical axis) of the convex surface of the third lens 4 that faces the objective side and the center (the optical axis) of the non-spherical surface of the third lens 4 that faces the image side.

According to the aforesaid design, the first, second and third lenses are respectively molded from a resin for the advantage of low manufacturing cost. Because the hole of the aperture is on the middle, the acceptable tolerance is relatively greater to facilitate the fabrication. The use of non-spherical lenses provides a relatively higher resolution and a relatively smaller chief ray angle, and a relatively less number of lenses can achieve the desired high image quality.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An image-forming lens set comprising a first lens, an aperture, a second lens and a third lens arranged orderly from an objective side toward an image side in sequence;
wherein the first lens is made of plastic material and has a positive diopter and two opposite surfaces including a convex surface facing the objective side, wherein at least one of the two opposite surfaces is a non-spherical surface;
wherein the second lens is made of plastic material and has a negative diopter and two opposite surfaces including a concave surface facing the objective side, wherein at least one of the two opposite surfaces of the second lens is a non-spherical surface; and
wherein the third lens is made of plastic material and has a positive diopter and two opposite surfaces including a convex surface facing the objective side, wherein at least one of the two opposite surfaces of the third lens is a non-spherical surface having an inflection point thereon.

2. The image-forming lens set as claimed in claim 1, wherein the diopter close to a border area of the concave surface of said second lens that faces the objective side reduces gradually toward the border edge.

3. The image-forming lens set as claimed in claim 1, wherein the two opposite surfaces of said first lens that respectively face the objective side and the image side are non-spherical surfaces.

4. The image-forming lens set as claimed in claim 1, wherein the two opposite surfaces of said second lens that respectively face the objective side and the image side are non-spherical surfaces.

5. The image-forming lens set as claimed in claim 1, wherein the two opposite surfaces of said third plastic lens that respectively face the objective side and the image side are non-spherical surfaces.

6. The image-forming lens set as claimed in claim 1, which satisfies the condition of TL/F<2, wherein TL is the distance between the peak of the convex surface of said first lens that faces the objective side and the image side, and f is the value of the equivalent focal distance of the image-forming lens set.

7. The image-forming lens set as claimed in claim 1, which satisfies the condition of V1>40, in which V1 is the dispersion coefficient of said first lens.

8. The image-forming lens set as claimed in claim 1, which satisfies the conditions of 0.1<|R4|/|R5|<5 and 0.1<|R6|/|R7|, in which |R4| is the absolute value of the radius of curvature of the concave surface of said second lens that faces the objective side; |R5| is the absolute value of the radius of curvature of the surface of said second lens that faces the image side; |R6| is the absolute value of the radius of curvature of the convex surface of said third lens that faces the objective side; and |R7| is the absolute value of the radius of curvature of the surface of said third lens that faces the image side.

9. The image-forming lens set as claimed in claim 1, which satisfies the condition of D5/f<0.3, wherein D5 is the distance between the peak of the surface of said second lens that faces the image side and the peak of the convex surface of said third lens that faces the objective side, and f is the value of the equivalent focal distance of the image-forming lens set.

10. The image-forming lens set as claimed in claim 1, which satisfies the condition of 0.2<D4/D6<2, wherein D4 is the distance between the center of the concave surface of said second lens that faces the objective side and the center of the surface of said second lens that faces the image side, and D6 is the distance between the center of the convex surface of the third lens that faces the objective side and the center of the surface of said third lens that faces the image side.
